(19) United States
(12) Patent Application Publication
(10) Pub. No.: US 2021/0323663 A1
(43) Pub. Date: Oct. 21, 2021

(54) UNMANNED AERIAL VEHICLE

(71) Applicant: AUTEL ROBOTICS CO., LTD., Shenzhen (CN)

(72) Inventor: Zhiying LIANG, Shenzhen (CN)

(21) Appl. No.: 17/361,671

(22) Filed: Jun. 29, 2021

Related U.S. Application Data
(63) Continuation of application No. PCT/CN2019/103051, filed on Aug. 28, 2019.

(30) Foreign Application Priority Data
Dec. 29, 2018 (CN) 201811639118.3

(51) Int. Cl. B64C 29/00; B64C 39/02

(52) U.S. Cl. CPC B64C 29/0033; B64C 39/024; B64C 29/0025; B64C 2201/104; B64C 2201/042; B64C 2201/108; B64C 2201/021

(57) ABSTRACT

The present invention relates to the technical field of unmanned aerial vehicles (UAVs) and discloses a UAV. The UAV includes: a fuselage, having a nose and a tail; a wing, connected to the fuselage; a tilt rotor assembly, mounted to the wing and rotatable to a first position or a second position relative to the fuselage; and a rotor assembly, disposed on the nose and/or the tail. During vertical take-off and landing of the UAV, the tilt rotor assembly rotates to the first position, and the tilt rotor assembly and the rotor assembly jointly provide lift for flight of the UAV. During enduring flight of the UAV, the tilt rotor assembly rotates to the second position, and only the tilt rotor assembly provides thrust for the enduring flight of the UAV. The rotor assembly and the tilt rotor assembly can enable the vertical take-off and landing and the enduring flight of the UAV.

### CROSS-REFERENCE TO RELATED APPLICATIONS

The present application is a continuation of International Application No. PCT/CN2019/103051, filed on Aug. 28, 2019, which claims priority to Chinese patent Application No. 2018116391183, filed on Dec. 29, 2018, which is incorporated herein by reference in its entirety.

### BACKGROUND

### Technical Field

The present invention relates to the field of unmanned aerial vehicles (UAVs), and in particular, to a UAV.

### Related Art

An unmanned aerial vehicle (UAV for short) is a new concept device under rapid development, which has the advantages of maneuverability, quick response, unmanned operation and low operation requirements.

UAVs include fixed-wing UAVs and rotor UAVs in terms of lift. The fixed-wing UAVs need to accelerate on the ground to take off, which impose relatively high requirements on a field. The rotor UAVs are incapable of long-time enduring flight.

### SUMMARY

In order to resolve the foregoing technical problems, embodiments of the present invention provide a UAV capable of vertically taking off and landing and a long-time enduring flight.

To resolve the foregoing technical problem, the embodiments of the present invention provide the following technical solutions:

A UAV is provided, including: a fuselage, having a nose and a tail; a wing, connected to the fuselage; a tilt rotor assembly, mounted to the wing and rotatable to a first position or a second position relative to the fuselage; and a rotor assembly, disposed on the nose and/or the tail. During vertical take-off and landing of the UAV, the tilt rotor assembly rotate to the first position, and the tilt rotor assembly and the rotor assembly jointly provide lift for flight of the UAV. During enduring flight of the UAV, the tilt rotor assembly rotate to the second position, and only the tilt rotor assembly provide thrust for the enduring flight of the UAV.

In some embodiments, the UAV further includes a tilt motor. The wing includes a wing body and a wing tip rotatable relative to the wing body. The tilt motor is disposed on the wing tip and connected to the wing body, the tilt rotor assembly is mounted to the wing tip, and the tilt motor drives the wing tip to drive the tilt rotor assembly to rotate to the first position or the second position relative to the fuselage.

In some embodiments, one of the wing body and the wing tip is provided with a rotary shaft, and the other of the wing body and the wing tip is provided with a shaft hole. The rotary shaft is mounted in the shaft hole, so that the wing tip is rotatable relative to the wing body.

In some embodiments, the shaft hole is provided on the wing tip, the rotary shaft is disposed on the wing body, one end of the rotary shaft is mounted in the shaft hole, and an other end of the rotary shaft is embedded in the wing body.

In some embodiments, the tilt motor is mounted in the wing tip, and a rotor of the tilt motor is connected to the rotary shaft.

In some embodiments, the rotary shaft is provided with a mounting hole, the rotor of the tilt motor being mounted in the mounting hole.

In some embodiments, the tilt motor is a servo motor.

In some embodiments, the rotor assembly includes a first rotor assembly disposed on the nose.

In some embodiments, the rotor assembly further includes a second rotor assembly disposed on the tail.

In some embodiments, the wing is rotatably connected to the fuselage, and the wing drives the tilt rotor assembly to rotate to the first position or the second position relative to the fuselage.

Compared with the prior art, the UAV in the embodiments of the present invention includes: a fuselage, having a nose and a tail; a wing, connected to the fuselage; a tilt rotor assembly, mounted to the wing and rotatable to a first position or a second position relative to the fuselage; and a rotor assembly, disposed on the nose and/or the tail. During vertical take-off and landing of the UAV, the tilt rotor assembly rotates to the first position, and the tilt rotor assembly and the rotor assembly jointly provide lift for flight of the UAV. During enduring flight of the UAV, the tilt rotor assembly rotates to the second position, and only the tilt rotor assembly provide thrust for the enduring flight of the UAV. The rotor assembly and the tilt rotor assembly enable the vertical take-off and landing and a relatively high endurance ability of the UAV.

### BRIEF DESCRIPTION OF THE DRAWINGS

One or more embodiments are described by way of example with reference to the corresponding figures in the accompanying drawings, and the exemplary descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a perspective view of a UAV according to an embodiment of the present invention, the UAV being in a continuous flight status.

FIG. 2 is a perspective view of the UAV shown in FIG. 1 in another status, the UAV being in a vertical take-off and landing status.

FIG. 3 is a front view of the UAV shown in FIG. 1.

FIG. 4 is a top view of the UAV shown in FIG. 1.

FIG. 5 is an A-A cross-sectional view of the UAV shown in FIG. 4.

FIG. 6 is a partially enlarged view of the UAV shown in FIG. 5 at position B.

FIG. 7 is a perspective view of another implementation of the UAV shown in FIG. 2.

FIG. 8 is a perspective view of still another implementation of the UAV shown in FIG. 2.

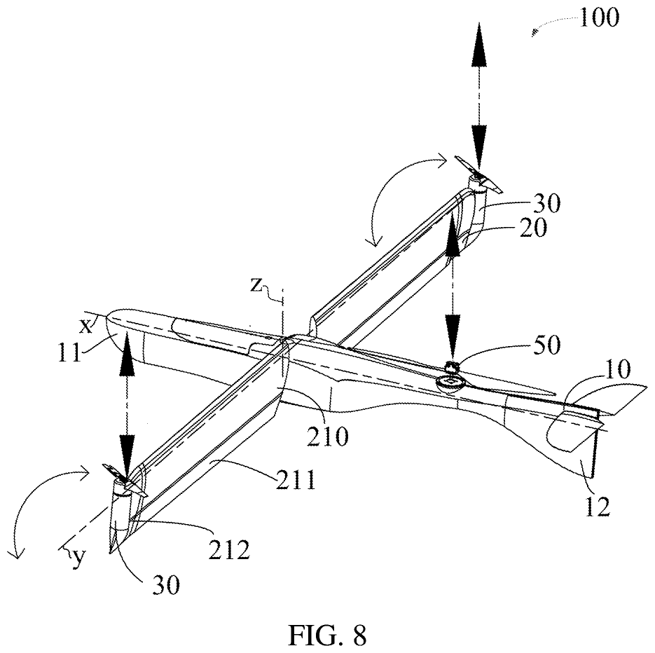

### DETAILED DESCRIPTION

For ease of understanding of the present invention, the present invention is described below in more detail with reference to accompanying drawings and specific implementations. It should be noted that, when a component is expressed as “being fixed to” another component, the component may be directly on the another component, or one or more intermediate components may exist between the component and the another component. When one component is expressed as “being connected to” another component, the component may be directly connected to the another component, or one or more intermediate components may exist between the component and the another component. The terms “vertical”, “horizontal”, “left”, “right”, “inner”, “outside”, and similar expressions used in this specification are merely used for an illustrative purpose.

Unless otherwise defined, meanings of all technical and scientific terms used in this specification are the same as those usually understood by a person skilled in art of the present invention. Terms used in the specification of the present invention are merely intended to describe objectives of the specific implementations, and are not intended to limit the present invention. A term “and/or” used in this specification includes any or all combinations of one or more related listed items.

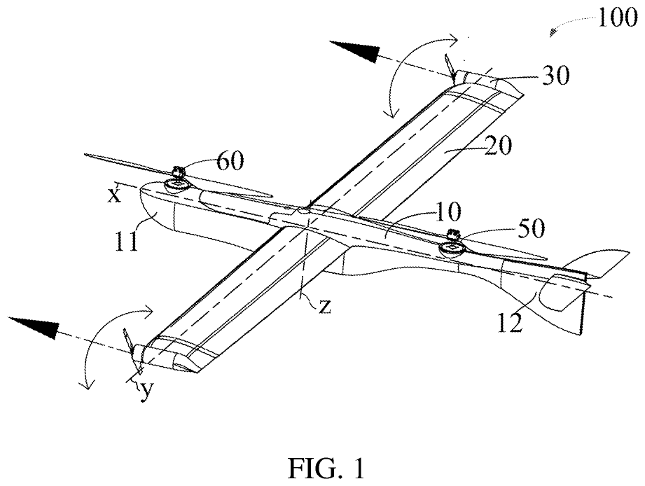

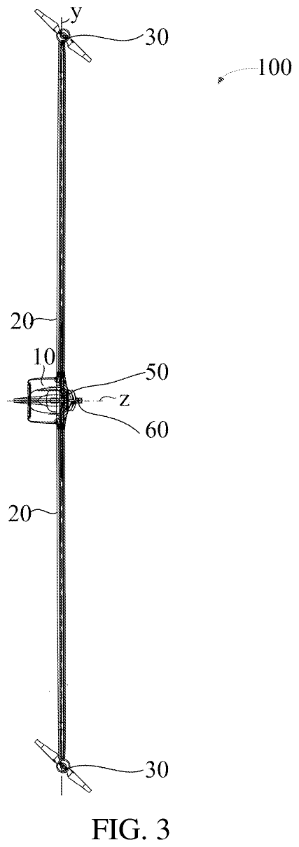

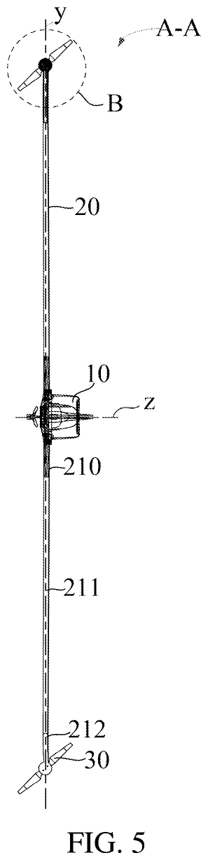

FIG. 1 to FIG. 5 show a UAV 100 according to an embodiment of the present invention. The UAV 100 includes a fuselage 10, a wing 20, a tilt rotor assembly 30, a tilt motor 40 and a rotor assembly. The wing 20 is disposed on two sides of the fuselage 10. The tilt rotor assembly 30 is mounted to the wing 20. The rotor assembly is mounted to the fuselage 10. The tilt rotor assembly 30 tilts to a first position or a second position relative to the fuselage 10. The tilt motor 40 is configured to directly drive the tilt rotor assembly 30 to tilt to the first position or the second position relative to the fuselage 10.

The UAV 100 has two statuses: a vertical take-off and landing status and a continuous flight status.

During vertical take-off and landing of the UAV, the tilt rotor assembly rotates to the first position, and the tilt rotor assembly 30 and the rotor assembly jointly provide lift for flight of the UAV 100. Thrust provided by the tilt rotor assembly 30 is substantially perpendicular to the ground. When the thrust provided by the tilt rotor assembly 30 is greater than a gravity of the UAV 100, the thrust provided by the tilt rotor assembly 30 can drive the UAV 100 to lift. Conversely, when the thrust provided by the tilt rotor assembly 30 is less than the gravity of the UAV 100, the thrust provided by the tilt rotor assembly 30 can drive the UAV 100 to descend.

When the UAV 100 lifts to a preset flight height, the UAV 100 can perform enduring flight. The tilt rotor assembly 30 tilts to the second position relative to the fuselage 10, so that only the tilt rotor assembly 30 provides thrust for the enduring flight for the UAV 100. Specifically, the thrust provided by the tilt rotor assembly 30 drives the UAV 100 forward. When the wing 20 crosses the air, a pressure difference is generated between an upper wing surface and a lower wing surface of the wing 20, so that the wing 20 generates lift to drive the UAV 100 to float. In addition, energy consumed by the tilt rotor assembly 30 to provide the thrust is much less than energy consumed by the tilt rotor assembly 30 to provide the lift. Therefore, compared with a vertical take-off and landing rotor UAV, the UAV 100 has a higher enduring flight ability.

In addition, the tilt motor 40 directly drives the tilt rotor assembly 30 to rotate relative to the fuselage 10. Since no transmission mechanism exists between the tilt motor 40 and the tilt rotor assembly 30, friction caused by use of the transmission mechanism during driving of the tilt rotor assembly 30 by the tilt motor 40 is avoided, indirectly reducing the energy consumed by the tilt motor 40 to drive the tilt rotor assembly 30, thereby further improving an endurance ability of the UAV 100.

The UAV 100 has a roll axis x, a pitch axis y and a heading axis z. The roll axis x, the pitch axis y and the heading axis z are perpendicular to each other two by two. The roll axis x, the pitch axis y and the heading axis z are all virtual straight lines defined in the present invention for ease of description. During vertical take-off and landing of the UAV 100, the UAV 100 takes off and lands substantially along the heading axis z. During enduring flight of the UAV 100, the UAV 100 flies substantially along the roll axis x.

The fuselage 10 is substantially in a shuttle shape. The fuselage 10 has a nose 11 and a tail 10. The nose 11 and the tail 12 of the fuselage 10 are both located on the roll axis x.

The fuselage 10 includes a control circuit assembly therein composed of electronic elements such as an MCU. The control circuit assembly includes a plurality of control modules, such as a flight control module configured to control a flight posture of the UAV 100, a Beidou module configured to navigate the UAV 100, a data processing module configured to process environmental information obtained by a related airborne device and the like.

The wing 20 extends in a direction parallel to the pitch axis y. The wing 20 includes a wing root 210, a wing body 211 and a wing tip 212. The wing root 210, the wing body 211 and the wing tip 212 are all located on the pitch axis y. The wing root 210 is connected to the fuselage 10.

The wing tip 212 is provided with the tilt rotor assembly 30.

In this embodiment, the wing root 212 is fixedly connected to the fuselage 10. For example, the wing root 212 is integrally formed with the fuselage 10. For another example, the wing root 212 is connected to the fuselage 10 by means of welding or riveting. The wing tip 212 is rotatably connected to the wing body 211. The tilt motor 40 is configured to directly drive the wing tip 212 to rotate about the pitch axis y relative to the fuselage 10.

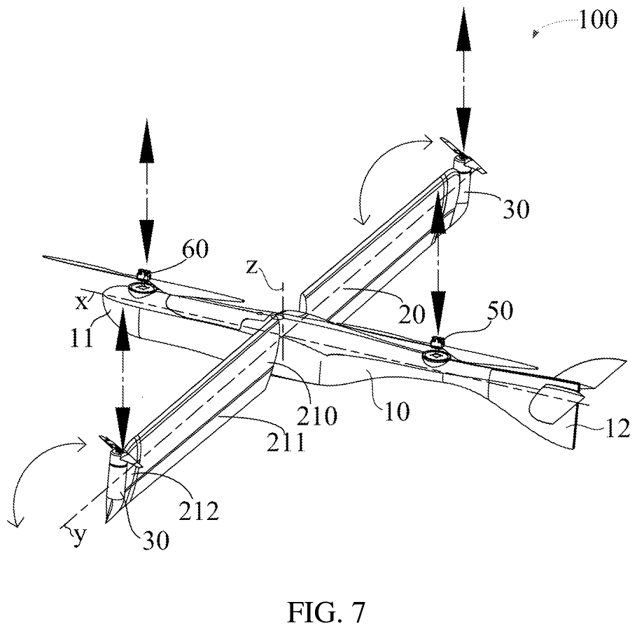

In some other embodiments, referring to FIG. 7, the wing root 212 is rotatably connected to the fuselage 10. For example, the wing root 212 is connected to the fuselage 10 by means of a shaft and a hole. The tilt motor 40 is configured to directly drive the entire wing 20 to rotate about the pitch axis y relative to the fuselage 10.

It is worth noting that, on the one hand, the tilt motor 40 directly drives the entire wing 20 to rotate. During the vertical take-off and landing of the UAV 100, since a wing surface (an upper wing surface or a lower wing surface) of the entire wing 20 is substantially parallel to a take-off and landing direction of the UAV, the wing 20 generates a small resistance, and the tilt rotor assemblies 30 consume little energy. On the other hand, the tilt motor 40 directly drives the wing tip 212 to rotate about the pitch axis y. Since a weight of the wing tip 212 is much less than a weight of the entire wing 20, the wing tip 212 has a small inertance, and accuracy of driving the wing tip 212 by the tilt motor 40 is higher.

It may be understood that, the wing 20 may partially rotate relative to the fuselage 10 or entirely rotate relative to the fuselage 10 according to actual situations, provided that the wing 20 is rotatably connected to the fuselage 10, and the wing drives the tilt rotor assembly 30 to rotate to the first position or the second position relative to the fuselage 10.

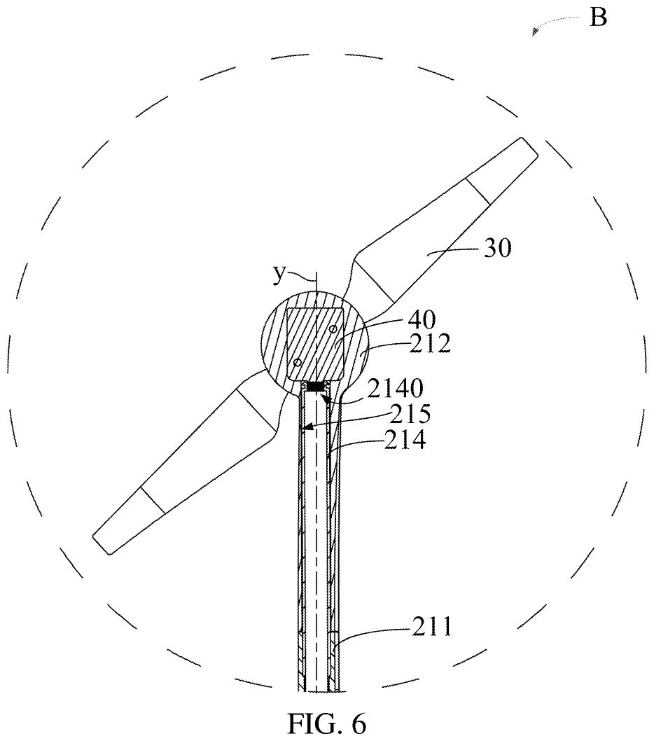

Referring to FIG. 6, the wing body 211 is provided with a rotary shaft 214 disposed thereon along the pitch axis y, and the wing tip 212 has a shaft hole 215 provided thereon along the pitch axis y. The rotary shaft 214 is connected to the shaft hole 215, so that the wing tip 212 is rotatable about the pitch axis y relative to the wing body 211. It may be understood that, the rotary shaft 214 and the shaft hole 215 may be transposed according to the actual situations, that is, the rotary shaft 214 is disposed on the wing tip 212, and the shaft hole 215 is provided on the wing body 211, provided that one of the wing tip 212 and the wing body 211 is provided with the rotary shaft 214 and an other is provided with the shaft hole 215.

In this embodiment, one end of the rotary shaft 214 is connected to the shaft hole 214, and an other end of the rotary shaft 215 is embedded in the wing body 211.

In some other embodiments, the rotary shaft 214 is integrally formed with the wing body 211.

The rotary shaft 214 is a hollow structure. An internal space of the rotary shaft 214 is used for wiring. The rotary shaft 214 has a mounting hole 2140 provided thereon. The mounting hole 2140 is configured to be connected to the tilt motor 40.

The tilt motor 40 is a servo motor. The tilt motor is mounted in the wing tip 212. A rotor of the tilt motor is mounted in the mounting hole 2140.

The tilt rotor assembly 30 includes two tilt rotor assemblies. Each of the tilt rotor assemblies 30 is mounted to a wing tip 212 of a corresponding one of wings 20. By disposing the tilt rotor assemblies 30 on wing tips 212 of the wings 20, the UAV 100 can take off and land or flight stably.

The rotor assembly is mounted to the nose 11 and/or the tail 12 of the fuselage 10.

The rotor assembly includes a first rotor assembly 50 and a second rotor assembly 60. The first rotor assembly 50 and the second rotor assembly 60 are both mounted to the fuselage 10. The first rotor assembly 50 and the second rotor assembly 60 are both configured to provide lift.

The first rotor assembly 50 is close to the tail 12 of the fuselage 10, and the second rotor assembly 60 is close to the nose 11 of the fuselage 10. By disposing the first rotor assembly 50 and the second rotor assembly 60, the UAV 100 has balanced lift on two sides of the roll axis x during vertical take-off and landing of the UAV 100.

The two tilt rotor assemblies 30, the first rotor assembly 50 and the second rotor assembly 60 form a quadrilateral, so that lift output points are provided around the UAV 100 during vertical take-off and landing of the UAV 100. In this way, the UAV 100 can take off and land stably.

It may be understood that, one of the first rotor assembly 50 and the second rotor assembly 60 may be omitted according to actual situations. Since the nose 11 of the fuselage 10 is closer to the wing 20 than the tail 12, the second rotor assembly 60 located on the nose 11 of the fuselage 10 is preferably omitted. The two tilt rotor assemblies 30 and the first rotor assembly 50 are distributed in a triangle. Based on the principle that three non-collinear points determine a plane, the two tilt rotor assemblies 30 and the first rotor assembly 50 are disposed, so that the lift for the UAV 100 is distributed in a plane during vertical take-off and landing of the UAV 100. In this way, the UAV 100 can vertically take off and land more stably.

Details of use of the UAV 100 are as follows:

During vertical take-off and landing of the UAV 100, the tilt motor 40 directly drives the wing tip 212 to rotate about the pitch axis y relative to the fuselage 10, the tilt rotor assemblies 30 rotate about the pitch axis y relative to the fuselage 10 with the wing tip 212, and the tilt rotor assemblies 30, the first rotor assembly 50 and the second rotor assembly 60 jointly provide lift to drive the UAV 100 to lift or descend along the heading axis z.

After the UAV 100 lifts to a preset flight height, the first rotor assembly 50 and the second rotor assembly 60 continue providing the lift, and the tilt rotor assemblies 30 gradually rotate about the pitch axis y relative to the fuselage 10. As the tilt rotor assemblies 30 gradually rotate, the lift provided by the tilt rotor assemblies 30 gradually decreases, while thrust provided by the tilt rotor assemblies 30 gradually increases, so that the UAV 100 gradually accelerates until the tilt rotor assemblies 30 provide only the thrust, and a flying speed of the UAV 100 is greater than a stall speed. In this case, the UAV 100 is in an enduring flight status.

When the UAV 100 is in the enduring flight status, the first rotor assembly 50 and the second rotor assembly 60 may stop working, and the tilt rotor assemblies 30 provide the thrust. When the UAV 100 flies, the wing 20 crosses the air, thereby generating lift on the wing 20.

Any of the tilt rotor assemblies 30, the first rotor assembly 50 and the second rotor assembly 60 includes a rotor motor and a propeller. The propeller is mounted to a rotor of the rotor motor. The rotor motor is configured to drive the propeller to rotate, so that the propeller provides lift or thrust. For example, a rotation axis of the propeller is substantially parallel to the heading axis z, and the propeller rotates to provide the lift. For another example, the rotation axis of the propeller is substantially parallel to the roll axis x, and the propeller rotates to provide the thrust.

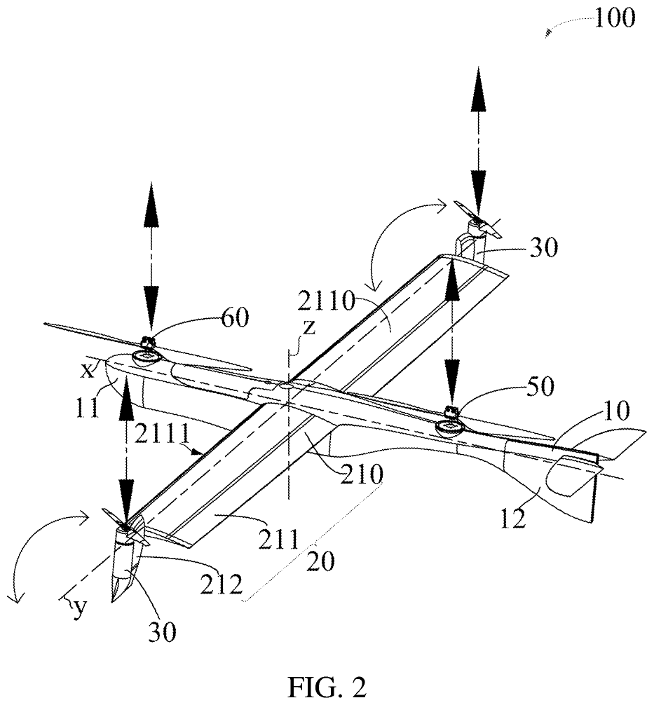

When the tilt rotor assemblies 30 rotate to the first position relative to the fuselage 10, as shown in FIG. 2, the propellers of the tilt rotor assemblies 30 are located on one side the upper wing surface 2110 of the wing body 211 faces, and rotation axes of the propellers of the tilt rotor assemblies 30 are parallel to the heading axis z.

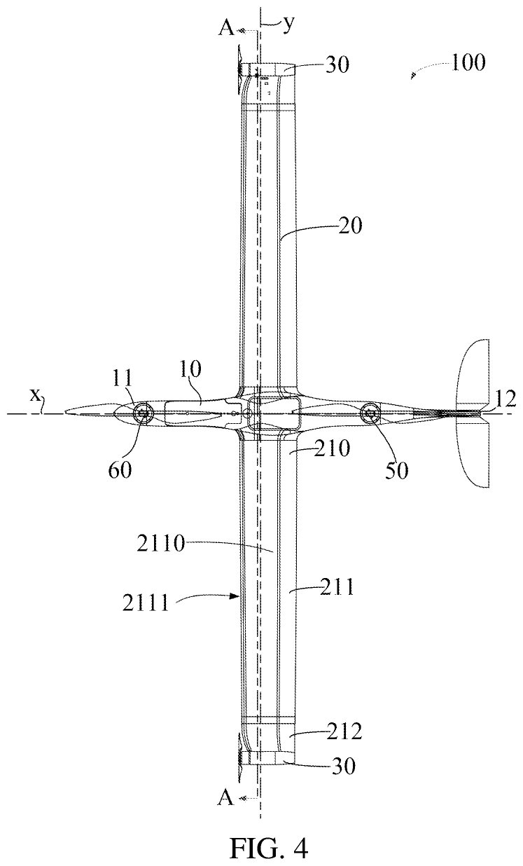

When the tilt rotor assemblies 30 rotate to the second position relative to the fuselage 10, as shown in FIG. 4, the propellers of the tilt rotor assemblies 30 are located on one side of a front edge 2111 of the wing body 211 faces, and the rotation axes of the propellers of the tilt rotor assemblies 30 are parallel to the roll axis x.

Compared with the prior art, in the UAV 100 provided in the embodiments of the present invention, the rotor assemblies and the tilt rotor assemblies 30, can enable the vertical take-off and landing and the enduring flight of the UAV 100.

In addition, since the tilt motor 40 directly drives the rotor assemblies 30 to rotate, friction caused by use of a transmission mechanism between the tilt motor 40 and the tilt rotor assemblies 30 is avoided, indirectly reducing the energy consumed by the tilt motor 40 to drive the rotor assemblies 30, thereby further improving an endurance ability of the UAV 100.

Finally, it should be noted that the foregoing embodiments are merely used to describe the technical solutions of the present invention, but are not intended to limit the present invention. Under the concept of the present invention, the technical features in the foregoing embodiments or different embodiments may be combined, the steps may be implemented in any sequence, and there may be many other changes in different aspects of the present invention. For brevity, those are not provided in detail. Although the present invention is described in detail with reference to the foregoing embodiments, a person of ordinary skill in the art should understand that they may still make modifications to the technical solutions described in the foregoing embodiments or make equivalent replacements to some technical features thereof, without departing from the scope of the technical solutions of the embodiments of the present invention.

What is claimed is:

1. An unmanned aerial vehicle (UAV), comprising:
a fuselage, having a nose and a tail;
a wing, connected to the fuselage;
a tilt rotor assembly, mounted to the wing and rotatable to a first position or a second position relative to the fuselage; and
a rotor assembly, disposed on the nose and/or the tail;
during vertical take-off and landing of the UAV, the tilt rotor assembly rotating to the first position, and the tilt rotor assembly and the rotor assembly jointly providing lift for flight of the UAV; and
during enduring flight of the UAV, the tilt rotor assembly rotating to the second position, and only the tilt rotor assembly providing thrust for the enduring flight of the UAV.

2. The UAV according to claim 1, further comprising a tilt motor, the wing comprising a wing body and a wing tip rotatable relative to the wing body, the tilt motor being disposed on the wing tip and connected to the wing body, the tilt rotor assembly being mounted to the wing tip, and the tilt motor driving the wing tip to drive the tilt rotor assembly to rotate to the first position or the second position relative to the fuselage.

3. The UAV according to claim 2, wherein one of the wing body and the wing tip is provided with a rotary shaft, and the other of the wing body and the wing tip is provided with a shaft hole, the rotary shaft being mounted in the shaft hole, so that the wing tip is rotatable relative to the wing body.

4. The UAV according to claim 3, wherein the shaft hole is provided on the wing tip, the rotary shaft is disposed on the wing body, one end of the rotary shaft is mounted in the shaft hole, and an other end of the rotary shaft is embedded in the wing body.

5. The UAV according to claim 4, wherein the tilt motor is mounted in the wing tip, and a rotor of the tilt motor is connected to the rotary shaft.

6. The UAV according to claim 5, wherein the rotary shaft is provided with a mounting hole, the rotor of the tilt motor being mounted in the mounting hole.

7. The UAV according to claim 2, wherein the tilt motor is a servo motor.

8. The UAV according to claim 1, wherein the rotor assembly comprises a first rotor assembly disposed on the nose.

9. The UAV according to claim 1, wherein the rotor assembly further comprises a second rotor assembly disposed on the tail.

10. The UAV according to claim 1, wherein the wing is rotatably connected to the fuselage, and the wing drives the tilt rotor assembly to rotate to the first position or the second position relative to the fuselage.
